(19) United States
(12) Patent Application Publication
(10) Pub. No.: US 2014/0145461 A1
(43) Pub. Date: May 29, 2014

(54) PORTABLE TRANSPORTATION HAND-HOLD DEVICE

(71) Applicant: Jonathan Broder, New Rochelle, NY (US)

(72) Inventor: Jonathan Broder, New Rochelle, NY (US)

(21) Appl. No.: 13/689,068

(22) Filed: Nov. 29, 2012

(51) Int. Cl. B60N 3/02; D05B 23/00

(52) U.S. Cl. CPC B60N 3/023; D05B 23/00
USPC 296/1.02; 29/428; 112/475.01

(57) ABSTRACT

The present invention is a personal, portable hanging device that allows a user to temporarily and securely engage transportation hand-holds (e.g. a grab bar on a subway, boat, train, etc.) in a sanitary manner. The elongate device includes two loops at each end that are connected by two rigid intermediate sections that extend from the end of each loop and the two intermediate sections are joined by a central section. The central section includes a material with a high coefficient of friction that helps prevent the device from sliding along the hand-hold when in use. The loops are sized and shaped to receive a user's hands so that the user can hold onto the device and indirectly be secured to the transportation hand-hold. The device also includes fasteners to temporarily secure the device to a handhold or fold the device in a sanitary manner for storage.

### TECHNICAL FIELD OF THE INVENTION

This patent application relates generally to the field of hanging devices and, in particular, devices configured to enable a user to engage a transportation hand-hold in a sanitary manner.

### BACKGROUND OF THE INVENTION

Shared transportation is an increasingly popular method of getting around in the present day and age. Virtually all of the shared transportation means, such as buses, trains, subways, boats, and the like include grab-bars or hand-holds that people hang on to while in transit to stay balanced when the moving vehicle stops, starts, turns or bounces around. Since numerous people use these bars and hand-holds in between cleanings, these areas harbor bacteria and are generally unsanitary. As such, it is desirable to provide a device that allows people who ride shared public or private transportation vehicles to easily, securely and repeatedly hang onto a myriad of different grab-bars and hand-holds in a sanitary manner.

It is with respect to these and other considerations that the disclosure made herein is presented.

### SUMMARY OF THE INVENTION

According to a first aspect, a portable hanging device configured to enable a user to engage a transportation hand-hold in a sanitary manner is provided. The hanging device includes a first and a second loop, wherein each loop is sized to receive a user's hand; a first and a second intermediate section extends from the end of the first loop and a second loop, respectively. The intermediate sections have a rigidity that is greater than the rigidity of the loops. The hanging device also includes a central section connected between the first and second intermediate sections having a first side and a second side. The first side of the central section is configured to provide a higher coefficient of friction than the second side. In addition, the rigidity of the central section is less than the rigidity of the first and second intermediate sections.

According to another aspect, a method of manufacturing a hanging device is provided, comprising: providing a continuous segment of strap having a first end and a second end; placing a friction material adjacent to the second side of the central section, wherein the friction material is configured to provide a higher coefficient of friction than the second side; folding the first and second ends of the strap to define a first loop, second loop, a first intermediate section, a second intermediate section, and a second side of a central section between the first and second intermediate sections; fixedly attaching the first end of the strap, and stiffening the first and second intermediate sections such that the rigidity of the intermediate sections is greater than the rigidity of the loops and the central section.

According to another aspect, a method of manufacturing a hanging device is provided, comprising: providing a continuous segment of strap having a first end and a second end, wherein the strap defines a first intermediate section, a second intermediate section, and a second side of a central section between the first and second intermediate sections; placing a friction material adjacent to the second side of the central section, wherein the friction material is configured to provide a higher coefficient of friction than the second side; folding the first and second ends of the strap to define a first loop, second loop; fixedly attaching the first and second end of the strap at the first and second intermediate sections; and stiffening the first and second intermediate sections such that the rigidity of the intermediate sections is greater than the rigidity of the loops and the central section.

According to another aspect, a method of manufacturing a hanging device is provided, comprising: providing a continuous segment of a strap having a central section, a first and a second intermediate section and a first end and a second end; overlaying a friction material on the strap, wherein the friction material is located at the central section of the strap and extends from the first intermediate section to the second intermediate section; Folding the first end to overlie the friction material and the strap at the first intermediate section so that the strap at the first intermediate section and the first end define the outermost layers of material at the first intermediate section; folding the second end to overlie the friction material at the second intermediate section so that the strap at the second intermediate section and the second end define the outermost layers of material at the second intermediate section; stitching through the first end, the friction material and the strap at the first intermediate section, to fixedly join the first end, friction material and strap at the first intermediate section; continuing stitching through the first end, friction material and the strap at the first intermediate section so that the first end, friction material and the strap are immovable relative to one another thereby imparting rigidity to the first intermediate section; concluding stitching to define a first loop sized to receive an adult sized hand; stitching through the second end, the friction material and the strap at the second intermediate section, to fixedly join the second end, friction material and strap at the second intermediate section; continuing stitching through the second end, friction material and the strap at the second intermediate section so that the second end, friction material and the strap are immovable relative to one another thereby imparting rigidity to the second intermediate section; and concluding stitching to define a second loop sized to receive an adult sized hand.

These and other aspects, features, and advantages can be appreciated from the accompanying description of certain embodiments of the invention and the accompanying drawing figures and claims.

### BRIEF DESCRIPTION OF THE DRAWINGS

FIG. 1 is a simplified diagram illustrating an exemplary configuration of a hanging device according to an embodiment of the present invention;

FIG. 2A is a simplified diagram illustrating an exemplary configuration of a hanging device according to an embodiment of the present invention;

FIG. 2B is a simplified diagram illustrating an exemplary configuration of a hanging device according to an embodiment of the present invention;

FIG. 3A is a diagram illustrating an exemplary configuration of a hanging device according to an embodiment of the present invention;

FIG. 3B is a diagram illustrating an exemplary configuration of a hanging device according to an embodiment of the present invention;

FIG. 4A is a diagram illustrating an exemplary configuration of a hanging device according to an embodiment of the present invention;

FIG. 4B is a diagram illustrating an exemplary configuration of a hanging device according to an embodiment of the present invention;

FIG. 5 is a diagram illustrating an exemplary configuration of a hanging device according to an embodiment of the present invention; and

FIG. 6 is a flow diagram showing a routine for manufacturing a hanging device according to an embodiment of the present invention.

### DETAILED DESCRIPTION OF CERTAIN EMBODIMENTS OF THE INVENTION

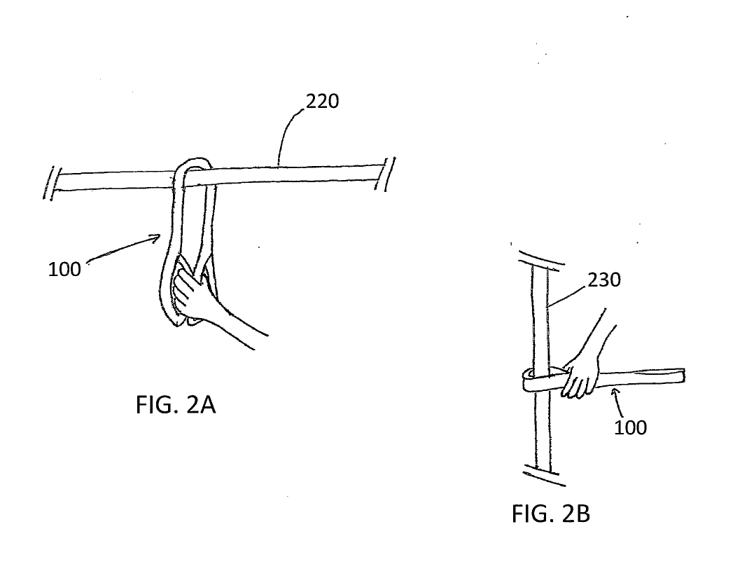

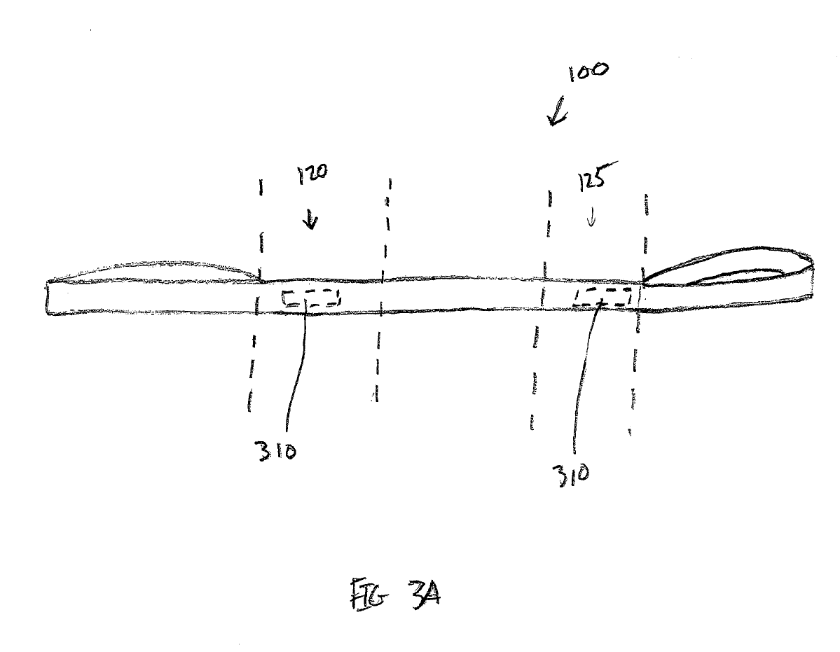

By way of overview and introduction what is disclosed is a portable hanging device that is configured to allow a user to engage a transportation hand-hold in a sanitary manner. As is well understood, hand-holds that are commonly found on transportation systems such as buses, trains, boats, automobiles and are meant to be held by the riders and prevent them from falling when jostled around in transit. These hand-holds however can harbor bacteria and are generally unsanitary when held by numerous individuals in between cleanings. The present invention is a personal, portable hanging device that allows a user to temporarily and securely engage transportation hand-holds in a sanitary manner. Because the hanging device allows a user to temporarily engage a hand-hold and is portable, the hanging device can be used numerous times. In an preferred arrangement the elongate hanging device includes two loops at each end that are sized to receive a user's hand. The two loops are connected by two rigid intermediate sections that extend from the end of each loop, and the two intermediate sections are joined by a central section. One side of the central section includes a material with a high coefficient of friction such as rubber. The hanging device is meant to be disposed around a hand-hold so that the “grippy” central section is in contact with the hand-hold and helps prevent the hanging device from sliding along the hand-hold when in use. The loops at the ends of the hanging device, and the intermediate sections are sized and shaped to receive the user's hands so that the user can hold onto the hanging device and indirectly be secured to the transportation hand-hold. The intermediate sections are rigid allowing the hanging device to be used on hand-holds that are in a vertical orientation (FIG. 2B) as well as a horizontal orientation (FIG. 2A) and anything in between. The hanging device also includes a plurality of fasteners that allows the user to temporarily secure the hanging device to a handhold when in use and also allow the user to fold the hanging device and store it without exposing the (possibly contaminated) surface of the hanging device that had been in contact with the unsanitary hand-hold to the user or the user's personal effects while the hanging device is stored in between uses.

The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods.

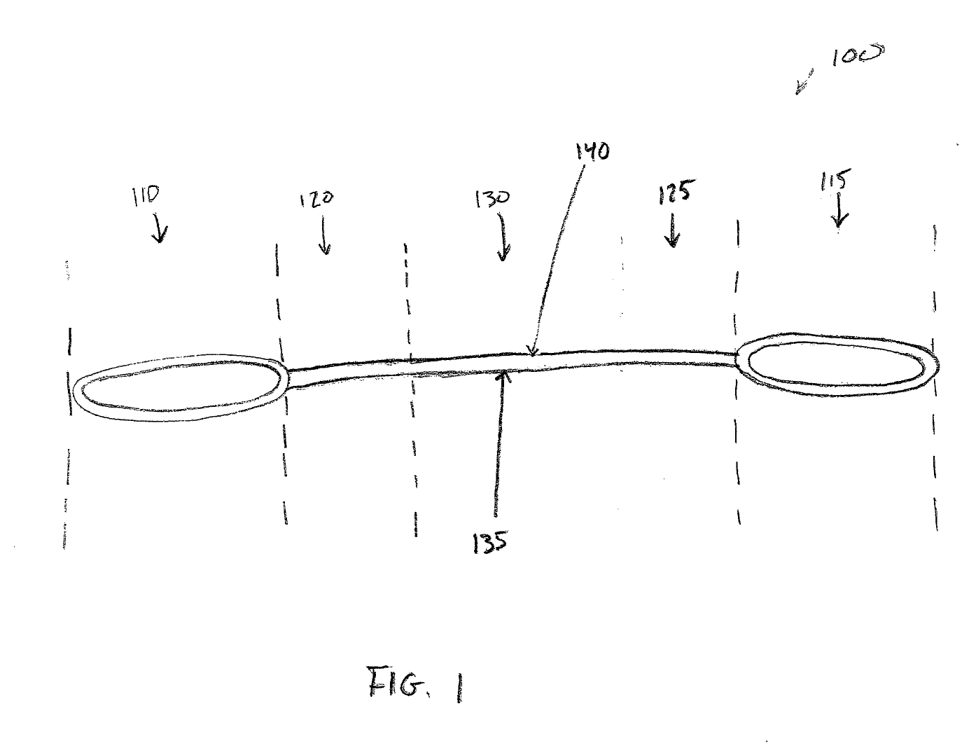

FIG. 1 depicts the hanging device according to an exemplary embodiment of the present invention. The hanging device 100, includes a first loop 110 and a second loop 115. Extending from the first loop is a first intermediate section 120 and extending from the second loop is a second intermediate section 125. Connecting the first and second intermediate sections to form a single, elongate hanging device is a central section 130. Central section includes a first side 135 and a second side 140.

The loops, intermediate sections and central section can be made from one or more distinct segments of material that are joined together. Alternatively, multiple sections of the hanging device can be defined by one or more continuous segments of material. The material used to define the various sections of the hanging device can include but is not limited to natural or synthetic textiles such as nylon, cotton or canvas, natural or synthetic leathers, polymers and the like. Like any personal accessory it is preferable for the material to be one that can be died, painted or otherwise colored. Furthermore, since the hanging device is often exposed to bacteria and unsanitary conditions, the material is also preferably washable such that it can easily be cleaned and disinfected. The material used can also be resistant to collecting and harboring dirt, bacteria and the like.

FIG. 2A depicts the hanging device 100 engaged in an intended fashion around a typical horizontal transportation hand-hold 220, or “grab bar” that is commonly found in trains, subways, boats and the like. In this exemplary use, the hanging device is situated around a hand-hold such that the central section 130 engages the hand-hold and the user can hold onto the first and second loops 110 and 115, respectively. Similarly, FIG. 2B depicts the hanging device 100 engaged in another intended fashion around a typical vertical hand-hold 230.

According to the exemplary embodiment, first and second loops are sized and shaped to receive a user's hand and are made of a generally flexible material that can be folded when the hanging device is not in use. Although the hanging device includes a first and second loop, alternatively the loops can be replaced with any lengths of material suitable for holding by a user such as handles and the like. In addition, while the loops can be made from a generally flexible, foldable material, alternatively, they can be made from a stiff material with flexible sections so the hanging device can be folded for storage.

Typical hand-holds found in transportation systems are vertical or horizontal bars, also called “grab bars” made from metal and are sized and shaped to receive a rider's hand. The diameter of grab bars can vary but are generally between one and three inches. According to the exemplary embodiment, the central section has a length that is suitable to engage at least a portion of a typical hand-hold. When the hanging device is in use, the first side 135 is the interior surface of the central section and is meant to engage a hand-hold. The second side defines the exterior surface of the hanging device. The first and second sides can be two separate pieces of material or can be a single piece of material. The second side is preferably a robust material that has a tensile strength suitable to withstand the tensile force that a user would put on the hanging device when holding onto the hanging device while it is secured to a hand-hold.

When riding a transportation system the user needs to have a secure grip on the hand-hold to keep from falling when the vehicle starts, stops or bounces around. Typical hand-holds are made from metal or other similar material and generally have a relatively low coefficient of friction. In order for the hanging device to be used without sliding around precariously the hanging device needs to allow the user to exert sufficient frictional force without undue difficulty. The amount of friction created by the strap is a function of the force applied to the handhold by the user and the coefficient of static friction of the first side that is in contact with the hand-hold. Accordingly, the first side is preferably a friction material that has a relatively high coefficient of static friction to increase the frictional force between the hanging device and hand-hold when in use, including but not limited to synthetic and natural polymer compounds such as rubbers and plastics. The friction material can be fixedly or removably attached to the second side. The friction material can be a single piece of material, such as a strip of rubber disposed along the length of the central section, adjacent to the second side. Alternatively, the friction material can be one or more pieces of material that are attached to the second side at specific locations along the central section. As a further alternative, friction material can be a material that is applied to the second side such as a spray on rubber compound. Alternatively, first side can be attached to the first and second intermediate portion so that the first side is not joined to the second side.

It is preferable for the central section to be flexible so the hanging device can be compactly folded for storage when not in use. In addition, it is desirable for the central section to be flexible such that when engaged with a hand-hold, the surface area of the contact patch between the first side and the hand-hold is large enough to provide sufficient frictional force when in use.

First and second intermediate sections 120 and 125 extend from the ends of the central portion and are connected to the ends of the first and second loops respectively. The intermediate sections are configured to have a rigidity that is greater than the central section thereby enabling the hanging device to be used with a vertically oriented hand-hold. When the hanging device is engaged with a horizontal hand-hold, the user can use the force of gravity to maintain a distance from the hand hold. However, gravity is not a significant aid in maintaining a distance from the hand hold when using the hanging device with a vertical hand-hold. As such, the intermediate sections are sized to allow a user to grasp both intermediate sections and hold tightly. Furthermore, the intermediate sections have a stiffness that prevents the device from collapsing when the user's hand moves towards the hand hold, for instance when the transportation vehicle stops, starts or sways from side to side. In addition, the stiff intermediate sections can allow the user to exert a squeezing force on the central section around a hand hold. Furthermore, it is preferable for the central section to be of a sufficient length such that when the user squeezes the intermediate sections together, the central section tightly grips the hand-hold.

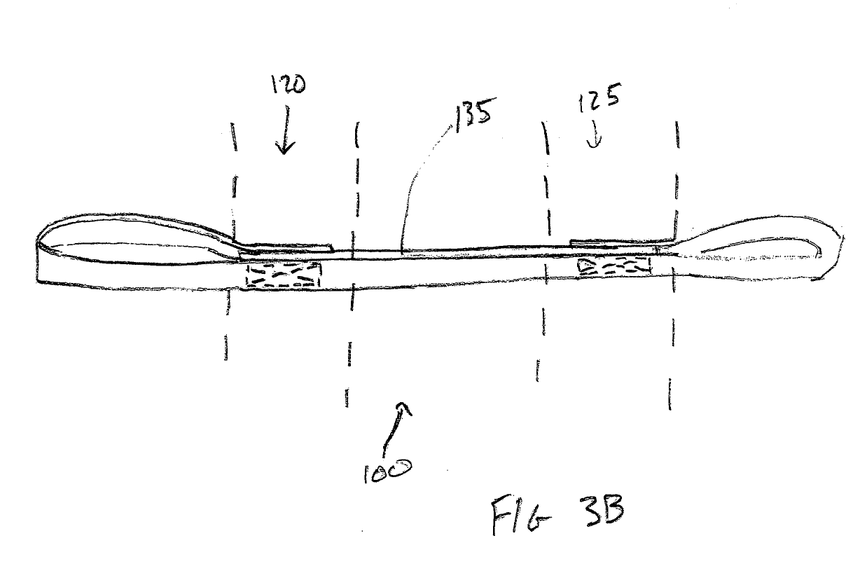

FIG. 3A depicts the hanging device 100 according to an exemplary embodiment of the present invention. In this exemplary embodiment, each of the first intermediate section 120 and second intermediate section 125 includes a stiffening insert 310 to increase the rigidity of the intermediate sections. The stiffening insert can be made of a light rigid plastic, such as acrylonitrile-butadiene-styrene copolymer, polyethylene, polyvinyl chloride, polycarbonate, polyproplene or styrene. It may, however, be made from any rigid material, such as wood or metal. The stiffening inserts can be fixedly attached to each of the intermediate sections by placing the insert between the material that defines the outer layers of the intermediate section and stitching around the periphery of the insert, thereby encasing the insert within the intermediate section. Alternatively, stiffening insert can be joined to the intermediate section with fasteners such as rivets and the like as would be well understood by a person of ordinary skill in the art. Alternatively, stiffening inserts can be removably joined to the intermediate section, for example and without limitation, by stitching a pocket on the intermediate section for receiving the insert.

Alternatively, as depicted in FIG. 3B, multiple layers of material can be joined together to increase the rigidity of the first intermediate section 120 and second intermediate section 125. For example and without limitation, the layers of material that define the intermediate sections and the friction material that makes up the first side 135 of central section can be layered and the layers stitched together such that they are immovable relative to one another, thereby imparting rigidity to the intermediate section.

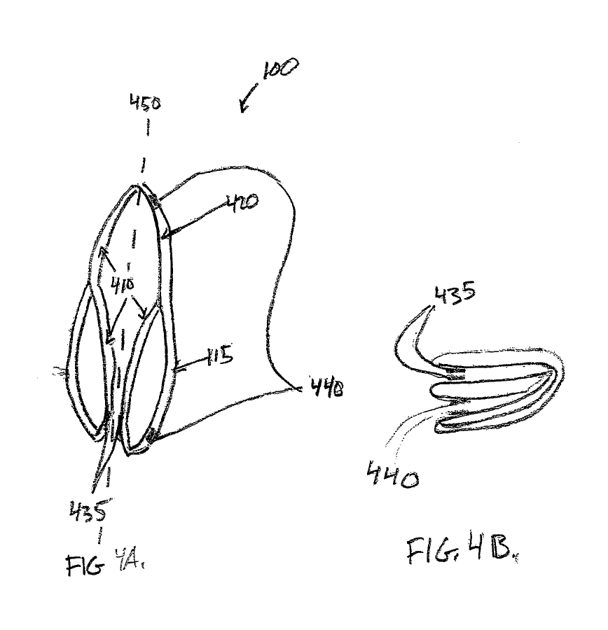

FIG. 4A and FIG. 4B depict a hanging device 100 according to an exemplary embodiment of the present invention. The hanging device includes an interior surface 410 and an exterior surface 420. In its intended use, the interior surface 410 is the surface that comes in contact with transportation hand-holds and is most likely to be exposed to unsanitary surfaces. A plurality of fasteners 435, 440 can be attached to both the interior and exterior surfaces of the hanging device. In the exemplary embodiment, the fasteners are matched pieces of Velcro (i.e. corresponding male and female pieces). Alternatively the fasteners can include but are not limited to snaps, buttons, magnets and the like.

A first matched pair of fasteners 435 (e.g. male and female portions of Velcro) can be affixed to the hanging device, on the interior surface such that each piece is disposed towards the ends of the first and second loops. The first pair of fasteners can temporarily secure the loops together preventing the hanging device from falling off a horizontal grab bar in the event that the user releases the first and second loops. In addition, the first pair of fasteners can temporarily join the ends of the loops together, so that the hanging device is folded in half, when the hanging device is not in use, thereby keeping the interior surface together and preventing it from being exposed when stored. Although the first pair of fasteners are placed towards the ends of the loops, the fasteners can be placed at other locations on the interior surface. Furthermore, more pairs of fasteners can be disposed along the length of the interior surface to keep the hanging device in place when in use and also keep the interior surface from inadvertent exposure when the hanging device is stored.

In addition, a second pair of fasteners 440 (e.g. male and female portions of Velcro) can also be attached to the exterior surface of the hanging device. As depicted in FIG. 4A, one fastener is disposed near the midpoint 450 of the hanging device, on the second loop 115 side of the midpoint. The other fastener is located towards the end of the second loop. As depicted in FIG. 4B, when the hanging device is folded in quarter by bringing the second loop to the center portion, the second pair of fasteners engage and hold the hanging device together for compact and easy storage. Alternative arrangements of fasteners can be implemented such that the hanging device can be folded in other configurations or rolled up as would be understood by a person of ordinary skill in the art.

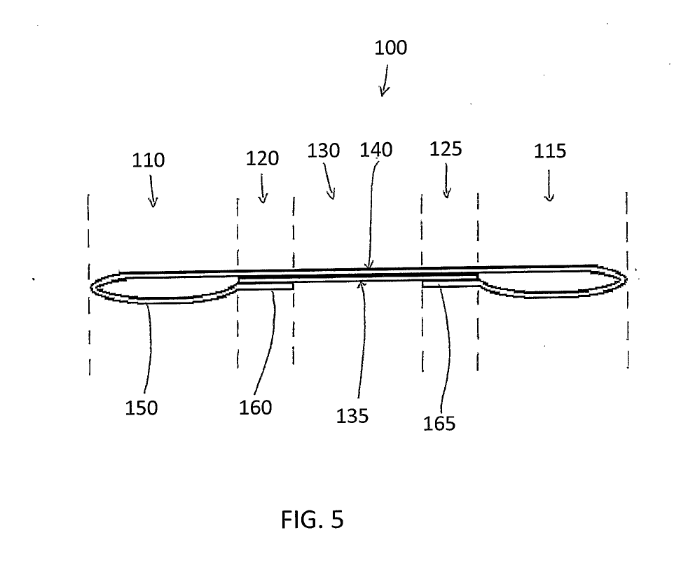

FIG. 5 depicts the hanging device according to an exemplary embodiment of the present invention. In the exemplary embodiment, the second side 140 of the central section, the first intermediate section 120 the second intermediate section 125 the first loop 110 and second loop 115 are defined by a single length of material, i.e. a strap 150 having a first end 160 and a second end 165. The first side 135 of the central section is an elongate piece of rubberized friction material that is disposed along the length of the strap extending from the first intermediate section 125 to the second intermediate section 125. The first end 160 of the strap is folded over to form the first loop 110. The portion of the strap defining one side of the first intermediate section 120, the friction material and the first end of strap are arranged to form three layers of material. These three layers of material are fixedly joined together such that they are immovable relative to each other and thereby imparting rigidity to the first intermediate section. Similarly, the second end 165 of the strap is folded over to form the second loop 115. The portion of the strap defining one side of the second intermediate section 125, the friction material and the second end of strap are arranged to form three layers of material and fixedly joined together such that they are immovable relative to each other and thereby imparting rigidity to the first intermediate section.

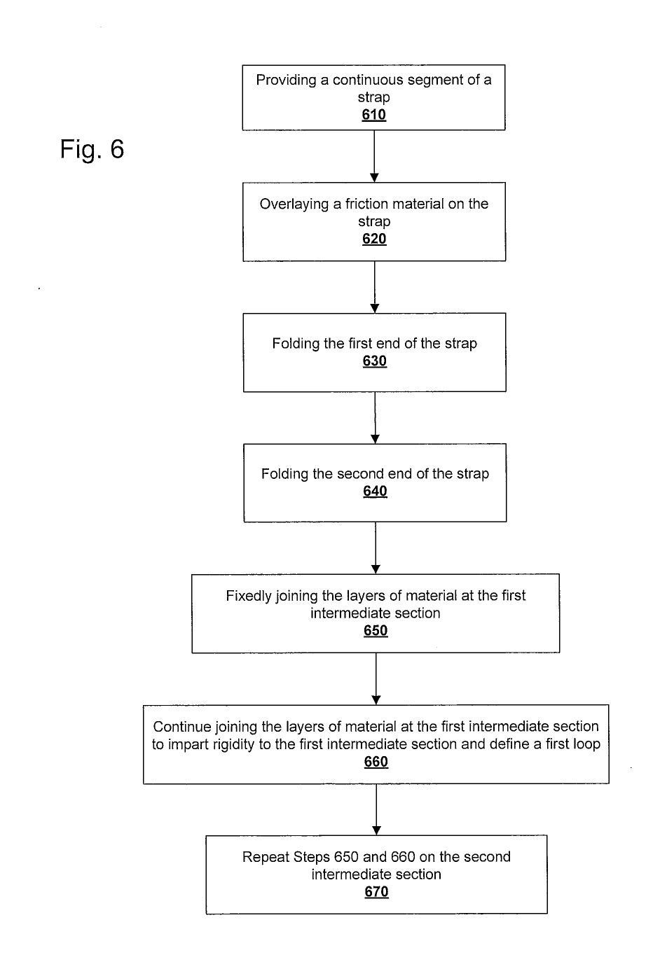

FIG. 6 is a flow diagram that illustrates a method of manufacturing a hanging device according to an exemplary embodiment of the present invention. Accordingly, the operations described herein are referred to variously as operations, steps, structural devices, or acts. It should be appreciated that more or fewer steps can be performed than shown in the figures and described herein. These steps can also be performed in a different order than those described herein.

The method of manufacture begins at step 610 where a continuous segment of a strap having a central section, a first and a second intermediate section and a first end and a second end is provided. The segment of strap can be a natural or synthetic textile such as nylon, cotton or canvas, or natural or synthetic leathers, polymers and the like.

Then at step 620 a friction material is overlaid on the strap. The friction material is laid across the central section of the strap. It is preferable that the friction material extends from the first intermediate section to the second intermediate section so that it can be secured to the strap at both of the intermediate sections. Additionally, the friction material can also be secured to the second side of the central section of the strap as well. This can be done by stitching or with an adhesive such as glue and the like.

Then at step 630, the first end of the strap is folded to overlie the friction material and the strap at the first intermediate section. Folding the first end over creates a loop and overlaying the strap on the strap at the first intermediate section and friction material creates a sandwich like construction where the strap at the first intermediate section and the first end define the outermost layers of the first intermediate section with the friction material in between. While the friction material can extend the entire length of the first intermediate section, this is not a requirement as the material can extend along only a portion of the first intermediate section.

Then at step 640, the second end of the strap is folded to overlie the friction material and the strap at the second intermediate section as in step 630.

Then at step 650, the layers of material at the first intermediate section are fixedly joined. This can be done by stitching through the first end, the friction material and the strap at the first intermediate section.

Then at step 660, the layers of material at the first intermediate section continue to be joined by continued stitching through the first end, friction material and the strap at the first intermediate section so that the first end, friction material and the strap are immovable relative to one another thereby imparting rigidity to the first intermediate section. The stitching also defines a first loop sized to receive an adult sized hand.

Then at step 670, the layers of material at the second intermediate section are fixedly joined as in steps 650 and 660.

The method of manufacturing can also include the step of overlaying a rigid insert on the strap and the friction material at each of the first and second intermediate sections prior to folding the first and second ends. When the first and second ends are folded over, the rigid inserts become one of the layers in a sandwich-like construction where the strap at the intermediate section and the end define the outermost layers of the intermediate section with the friction material and rigid insert in between. In addition, joining the layers of material that make up the intermediate sections can include the step of stitching around the rigid insert so as to create a sealed pocket surrounding the rigid inserts. The rigid inserts thereby increase the stiffness of the intermediate sections when attached to the intermediate sections of the hanging device.

Thus, while there have been shown, described, and pointed out fundamental novel features of the invention as applied to several embodiments, it will be understood that various omissions, substitutions, and changes in the form and details of the devices illustrated, and in their operation, may be made by those skilled in the art without departing from the spirit and scope of the invention. Substitutions of elements from one described embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

What is claimed:

1. A portable hanging device configured to enable a user to engage a transportation hand-hold in a sanitary manner, comprising:
a first and a second loop, wherein each loop is sized to receive a user's hand;
a first intermediate section extending from an end of the first loop and a second intermediate section extending from an end of the second loop, wherein the intermediate sections have a rigidity that is greater than the rigidity of the loops; and
a central section connected between the first and second intermediate sections having a first side and a second side, wherein the first side is configured to provide a higher coefficient of friction than the second side and wherein the rigidity of the central section is less than the rigidity of the first and second intermediate sections.

2. The hanging device of claim 1, wherein the first and second loops, the first and second intermediate sections and the second side of the central section are defined by a continuous segment of strap.

3. The hanging device of claim 1, further comprising a rigid insert along each of the first and second intermediate sections.

4. The hanging device of claim 1, further comprising a plurality of fasteners attached to the loops and to the second side of the central section, the fasteners being configured to temporarily join the loops and the central section and to retain the hanging device in a folded state when not in engagement with the transportation hand-hold.

5. The hanging device of claim 1, wherein the first side is comprised of a friction material disposed along the length of the central section.

6. The hanging device of claim 1, wherein the first side is comprised of a plurality of pieces of a friction material disposed along the length of the central section.

7. The hanging device of claim 5, wherein the friction material is removably attached to the second side.

8. The hanging device of claim 5, wherein the friction material is fixedly attached to the second side.

9. The hanging device of claim 5, wherein the friction material is fixedly attached to each of the intermediate sections by a coupling and wherein the first side and coupling provide increased rigidity to each of the intermediate sections.

10. The hanging device of claim 1, wherein the loops, intermediate sections and central section extend along a length and wherein a width of the central section in a direction perpendicular to the length is greater than the width of the first and second loops.

11. The hanging device of claim 1, wherein the central section is sized to correspond to the size of the hand-hold.

12. A method of manufacturing a hanging device, comprising the steps of:
a) providing a continuous segment of strap having a first end and a second end, wherein the strap defines a first intermediate section, a second intermediate section, and a second side of a central section between the first and second intermediate sections;
b) placing a friction material adjacent to the second side of the central section, wherein the friction material is configured to provide a higher coefficient of friction than the second side;
c) folding the first and second ends of the strap to define a first loop, second loop;
d) fixedly attaching the first and second end of the strap at the first and second intermediate sections; and
e) stiffening the first and second intermediate sections such that the rigidity of the intermediate sections is greater than the rigidity of the loops and the central section.

13. The method of claim 11, further comprising the step of attaching a plurality of fasteners to the first and second loops and to the central section to permit temporary joinder of the loops so as to retain the hanging device in a folded state.

14. The method of claim 11, wherein the step of stiffening the first and second intermediate sections includes attaching a rigid insert to each of the first and second intermediate sections.

15. The method of claim 11, wherein the step of stiffening the first and second intermediate sections includes attaching the friction material to the first and second intermediate sections.

16. A method of manufacturing a hanging device, comprising the steps of:
a) providing a continuous segment of a strap having a central section, a first and a second intermediate section and a first end and a second end;
b) overlaying a friction material on the strap, wherein the friction material is located at the central section of the strap and extends from the first intermediate section to the second intermediate section;
c) folding the first end to overlie the friction material and the strap at the first intermediate section so that the strap at the first intermediate section and the first end define the outermost layers of material at the first intermediate section;
d) folding the second end to overlie the friction material at the second intermediate section so that the strap at the second intermediate section and the second end define the outermost layers of material at the second intermediate section;
e) stitching through the first end, the friction material and the strap at the first intermediate section, to fixedly join the first end, friction material and strap at the first intermediate section;
f) continuing stitching through the first end, friction material and the strap at the first intermediate section so that the first end, friction material and the strap are immovable relative to one another thereby imparting rigidity to the first intermediate section;
g) concluding stitching to define a first loop sized to receive an adult sized hand;
h) stitching through the second end, the friction material and the strap at the second intermediate section, to fixedly join the second end, friction material and strap at the second intermediate section;
i) continuing stitching through the second end, friction material and the strap at the second intermediate section so that the second end, friction material and the strap are immovable relative to one another thereby imparting rigidity to the second intermediate section; and
j) concluding stitching to define a second loop sized to receive an adult sized hand.

17. The method of claim 16, further comprising the step of overlaying a rigid insert on the strap and the friction material at each of the first and second intermediate sections prior to folding the first and second ends.

18. The method of claim 17, further comprising the step of stitching around the rigid insert at the first intermediate section so as to create a sealed pocket surrounding the rigid insert.

19. The method of claim 16, further comprising the step of applying an adhesive to the friction material prior to the step of overlaying a friction material on the strap.
